(19) United States
(12) Patent Application Publication
(10) Pub. No.: US 2026/0280026 A1
(43) Pub. Date: Sep. 17, 2026

(54) COVER FOR A BATTERY OF A MOBILITY VEHICLE

(71) Applicant: VALEO EMBRAYAGES, Amiens (FR)

(72) Inventor: Roel VERHOOG, Amiens (FR)

(73) Assignee: VALEO EMBRAYAGES, Amiens (FR)

(21) Appl. No.: 19/469,259

(22) PCT Filed: Mar. 28, 2024
(86) PCT No.: PCT/EP2024/058609

§ 371 Date: Sep. 25, 2025

(30) Foreign Application Priority Data
Mar. 31, 2023 (FR) FR2303165

(51) Int. Cl. H01M 50/325; B60L 50/64; B60L 58/26; H01M 10/42; H01M 10/48; H01M 10/613; H01M 10/633; H01M 10/6561; H01M 50/147

(52) U.S. Cl. CPC H01M 50/325; B60L 50/64; B60L 58/26; H01M 10/425; H01M 10/486; H01M 10/613; H01M 10/633; H01M 10/6561; H01M 50/147; B60L 2240/545; H01M 2220/20

(57) ABSTRACT

A cover for a battery of a mobility vehicle, which is designed to be installed between the battery and a passenger space of the mobility vehicle. The cover includes at least one first air circulation duct provided with a shutter, which may be displaced between an open position and a closed position. A battery housing may include the cover.

The present application concerns the domain of batteries of mobility vehicles, in particular mobility vehicles comprising an electric motor and at least one wheel. The present invention involves batteries used in electric vehicles, hybrid electric vehicles, or rechargeable hybrid electric vehicles.

As electric or hybrid mobility, notably combining electric and thermal propulsion, becomes more widespread, it is necessary to monitor the capacity, efficiency and service life, as well as the safety of the batteries used.

In the event of a thermal problem with the battery, for example an internal or external short-circuit, it is known for a ventilation phenomenon to occur. This poses a problem in particular for a battery which is cooled by air, since the gases emitted may then be mixed with the cooling circuit, or even reach the passenger space.

If the battery overheats or is set on fire, it is necessary to prevent the toxic gases, or the flames, from penetrating into the passenger space, and at least retard the propagation of these gases or flames, thus giving the occupants time if necessary to leave the passenger space and get to safety.

In the solutions known at present, the flow of air to the passenger space is generally blocked by a valve in passive operation. The valve is opened under the effect of low pressure caused by the ventilation system. It is closed by the action of gas coming from the battery. These solutions have the disadvantage of giving rise to energy losses. In addition, the closure force of the valve is not very high. These solutions require a compromise between the losses of air flow and the sealing of the valve. There is a need to improve the safety of the batteries.

In order to fulfil some or all of these needs, according to a first aspect, the subject of the invention is a cover for a battery of a mobility vehicle, which is designed to be installed between the battery and a passenger space of the mobility vehicle, said cover comprising at least one first air circulation duct provided with a shutter, which may be displaced between an open position and a closed position, and an actuator in order to displace the shutter between the open position and the closed position, the actuator being designed to receive a signal obtained from a battery control system and/or from an autonomous sensor, and to control the closure and/or the opening of the shutter after receipt of a trigger event signal, the battery control system comprising at least one battery alert threshold, beyond which the shutter is displaced and remains in the closed position.

In order to fulfil some or all of these needs, according to a first aspect, the subject of the invention is a cover for a battery of a mobility vehicle, which is designed to be installed between the battery and a passenger space of the mobility vehicle, said cover comprising at least one air circulation duct provided with a shutter, which may be displaced between an open position and a closed position.

In particular, the first air circulation duct allows the air coming from the passenger space, in particular the recycled air, to be conveyed to the battery.

For example, the shutter pivots around an axis of rotation.

In a particular embodiment, when the shutter is in the open position, the first duct allows the air to circulate from the passenger space to the battery, and conversely, from the battery to the passenger space. In this case, the cover may advantageously comprise a filtration system in order to eliminate any noxious gases released by the battery.

In a variant, when the shutter is in the open position, the air may circulate only from the passenger space to the battery.

In a preferred embodiment, the cover comprises an actuator, in order to displace the shutter between the open position and the closed position.

By displacing the shutter thus from the open position to the closed position, the actuator activates the aeraulic insulation of the battery in relation to the passenger space.

The shutter is in particular connected to an output shaft of the actuator.

The actuator is designed to receive a signal coming from a system for control of the battery and/or of at least one autonomous sensor, and to control the closure and/or opening of the shutter after the receipt of a trigger event signal.

“Autonomous sensor” means in particular a sensor which is provided with an independent electrical supply, and/or incorporates data recording capacities, and/or is self-sufficient, i.e. without interaction with other sensors or computers, in order to send a signal permitting control of the closure and/or opening of the shutter.

The autonomous sensor(s) which is/are designed to send signals to the actuator are in particular selected from among a battery temperature sensor, a passenger space temperature sensor, an exterior air temperature sensor, a supply detector of a fan connected to the battery, a pressure sensor of at least one cell of the battery, a voltage sensor of the cells, a current sensor, a sensor for measurement of the level of presence of gas in the air, a sensor for measurement of the presence of fumes and/or the level of particles in suspension in the air produced during combustion, or a sensor which is sensitive to the thermal radiations emitted by flames.

In one embodiment, the battery control system, also known as the BMS, i.e. Battery Management System, sends a signal to the actuator, which is a result of the analysis of the parameters measured by the sensors, in particular those for the temperature, voltage and current of the battery.

Within the context of the invention, “trigger event” means a change of value of at least one parameter associated with the battery, which gives rise to a displacement of the shutter.

When the battery is stopped or in charging mode, the shutter is for example in the closed position.

When the battery is operating, the shutter may be in the open or closed position depending on the exterior conditions determined, indicated in particular by the battery control system and/or at least one autonomous sensor.

The position of the shutter may depend on the temperature in the interior of the passenger space, and/or on the temperature of the battery. It may depend on whether the fan associated with the battery is operating or not.

In a particular example, when the battery is started, if as a result of its thermal inertia it is still hot from previous usage, and has a temperature higher than the set temperature of the passenger space, the shutter may be open, and the air may circulate from the battery to the passenger space for a given period, or, in a variant, until the temperature of the passenger space has reached a set temperature.

The battery control system, also known as the BMS, i.e. Battery Management System, may comprise a low and/or a high temperature threshold corresponding to a preferential operating range of the battery. The values of these parameters of the battery control system, respectively the low temperature threshold and the high temperature threshold, are determined on the basis of criteria of efficiency of the battery and comfort in the interior of the passenger space. The low threshold is for example 15° C. or in the vicinity thereof, and the high threshold is between 30° C. and 35° C.

The battery control system also comprises at least one alert threshold, beyond which the shutter is displaced and remains in the closed position.

The at least one alert threshold may be selected as a predefined maximum value corresponding to a risk for the safety of the occupants of the passenger space of the mobility vehicle, in particular a risk of fire and/or a risk of emanation of gas.

The at least one alert threshold may be a temperature alert threshold of the battery.

A maximum value of the temperature alert threshold of the battery may be predefined, with the maximum value of the temperature alert threshold of the battery being able to be between 60° C. and 120° C., preferably between 80° C. and 120° C.

The at least one alert may be an alert threshold for the presence of gas corresponding to a predefined maximum level for the presence of a gas in the air, such as, in particular, the gases with the chemical compositions H2 and/or CO2 and/or CO and/or HF and/or POF3. The maximum predefined level of the alert threshold for the presence of a gas in the air may be between 4,000 and 12,000 ppm for the gas H2, between 5,000 and 15,000 ppm for the gas CO2, between 20 and 100 ppm for the gas CO, and between 1.8 and 3 ppm for the gases HF and POF3.

Other types of alert threshold may be predefined from the signals sent by the autonomous sensor(s), in particular the alert thresholds associated with the voltage of the battery, or the intensity of the battery, or the measurement of the presence of fumes, and/or the level of particles in suspension in the air produced during combustion, or also the measurement of thermal radiation emitted by flames.

According to other embodiments, as a complement or as an alternative:
when the temperature of the battery is strictly higher than the high threshold, the shutter is in the open position, and the air circulates from the passenger space to the battery, unless the temperature of the passenger space is higher than, or the same as, the temperature of the battery. In this last case, the shutter is closed;
when the temperature of the battery and the temperature of the passenger space are between the low and high temperature thresholds, the shutter is in the closed position;
when the temperature of the battery is strictly lower than the low threshold, and strictly lower than the temperature of the passenger space, the shutter is in the open position. The intake of air from the passenger space to the battery makes it possible to heat the battery and improve its performance;
when the temperature of the battery is between the low and high temperature thresholds, i.e. when the battery is in its preferential temperature range, and the temperature of the passenger space is strictly lower than the low temperature threshold or strictly higher than the high temperature threshold, the shutter is in the open position, and the air circulates from the battery to the passenger space. Thus, the air intake from the battery makes it possible to improve the comfort of the passenger space.

A trigger event for sending a signal and giving rise to the displacement of the shutter is for example associated with a vibration at the level of the temperature of the battery and/or the temperature of the passenger space, in relation to the temperature thresholds. Another trigger event may be associated with the comparison of the temperatures of the battery of the passenger space.

The actuator is in particular selected from among a gear motor, a step motor, a toothed rack or pinion system, or a return unit system.

The actuator is for example connected to an external wall of the first air circulation duct.

Preferably, the displacement between the open position and the closed position is reversible. In other words, the shutter is designed in particular to pivot in the first duct in two directions of rotation between the open and closed positions.

In a variant, the displacement is irreversible, except for optionally with exterior intervention. In other words, in the case of irreversible displacement, once the shutter is in the closed position, the return to the open position is possible only by replacing some or all of the cover, or at least by displacing the shutter manually to the open position.

In a variant, the displacement between the open position and the closed position may be reversible, for as long as the at least one alert threshold of the battery control system has not been reached.

In a variant, the displacement of the shutter may be irreversible, with the shutter which is being displaced then being maintained locked in the closed position when the at least one alert threshold of the battery control system has been reached.

Depending on the embodiments, the cover according to the invention may alternatively or additionally have one of the following characteristics:
the cover comprises at least one second air circulation duct, in particular an external air input duct, and/or at least one third air circulation duct, in particular an air output duct;
the shutter is of the drum type, and may thus comprise a portion of cylinder limited by lateral cheeks;
the shutter is a butterfly valve or a sliding valve;
the first duct is not limited to a particular form. The first duct may thus have a transverse cross-section which is at least partly polygonal;
the cover may comprise a perforated or grid part, in order to separate the first duct from the passenger space;
the shutter may comprise an edge which is made at least partly from soft material, in order to ensure better sealing in the closed position;
the shutter may be made from a material which is resistant to high temperatures, in particular a material having a melting temperature higher than 250° C.;
the shutter may be made from a material containing flame-retardant additives or a material covered with a coating containing flame-retardant additives;
the shutter may be made from a material which is intumescent, or a material covered with an intumescent coating.

According to another aspect, the subject of the invention is a battery housing comprising a cover as previously described.

Said housing comprises in particular at least one second air circulation duct, in particular an external air input duct, and/or at least one third air circulation duct, in particular an air output duct.

According to the different variants of the invention, the second air circulation duct and/or the third air circulation duct of the housing do or do not belong to the cover.

According to the different variants of the invention, the at least one second duct and/or the at least one third duct may each comprise a shutter as previously described in the present application.

According to yet another aspect, the subject of the invention is an assembly for a mobility vehicle comprising a battery and a cover or a housing as previously described.

In a particular example, the assembly also comprises a fan. The operation of the fan may in particular control the displacement of the shutter to the open position.

Further characteristics, details and advantages of the invention will become more clearly apparent from reading the following description provided by way of indication with reference to drawings, in which:

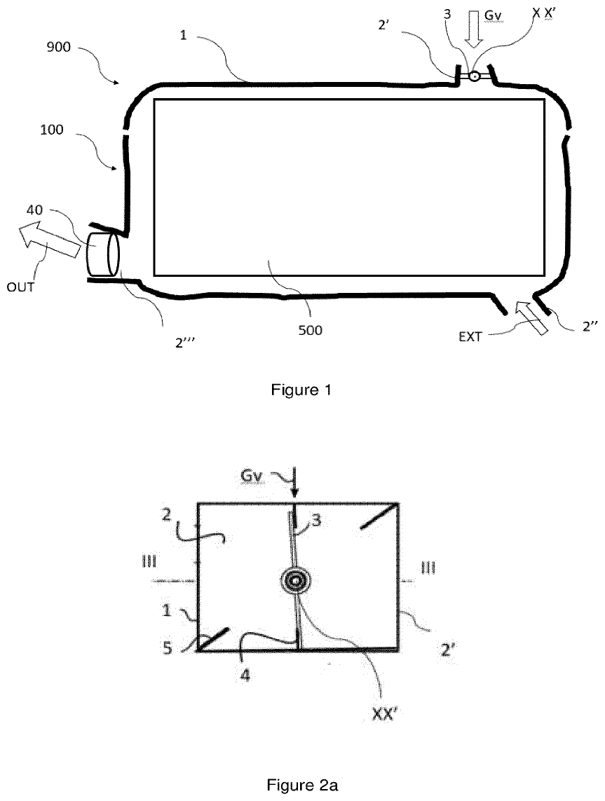

FIG. 1 illustrates an assembly for a mobility vehicle according to the invention;

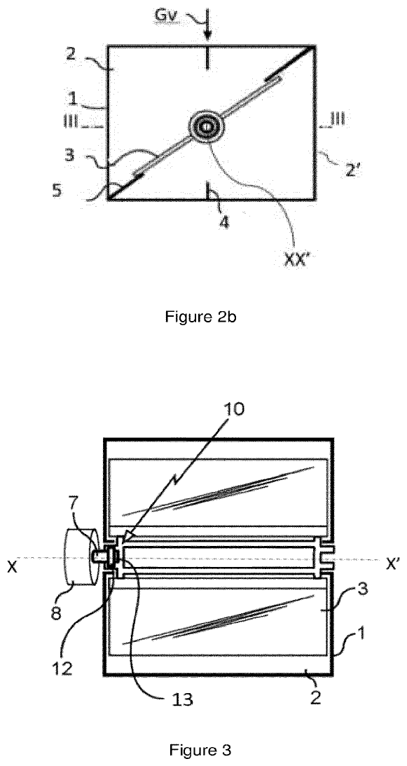

FIG. 2a is a partial schematic view of a cover according to a first embodiment of the invention, in the open position of the shutter;

FIG. 2b is a partial schematic view of the cover of FIG. 2a, the shutter being in the closed position;

FIG. 3 is an axial view in cross-section according to III-III of the duct of FIGS. 2a-2b; and

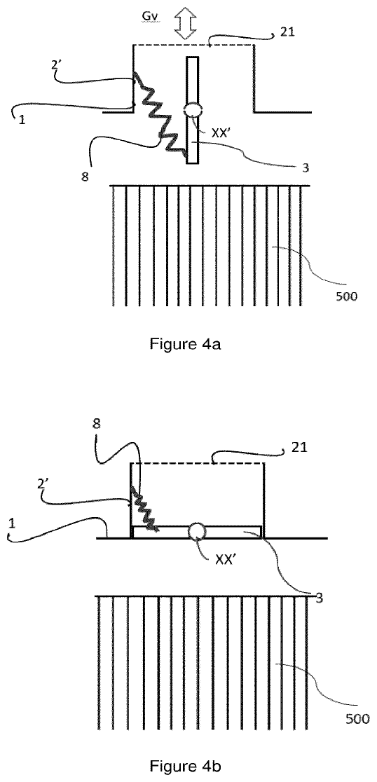

FIGS. 4a and 4b are schematic views of a cover according to a second embodiment of the invention, respectively in the open position of the shutter and the closed position.

In these figures, similar elements have the same reference signs. The arrow Gv shows in the figures the direction of circulation of the air passing through the first duct 2′, in particular coming from the passenger space of the vehicle.

The following embodiments are examples. Although the description refers to one or more embodiments, this does not necessarily mean that each reference relates to the same embodiment, or that the characteristics apply only to a single embodiment. Individual characteristics of different embodiments may also be combined or exchanged to provide other embodiments.

In the description, certain objects may be indexed, such as first object or second object or third object, for example. In this case, such indexing merely differentiates and denotes objects that are similar but not identical. This indexing does not imply that one object takes priority over another and such denominations may easily be inverted without departing from the scope of the present description. Likewise, such indexing does not imply any chronological order.

FIG. 1 illustrates an assembly 900 of a battery 500 and a housing 100 accommodating said battery.

In the example illustrated, the housing 100 comprises a cover 1. Said cover 1 comprises a first air circulation duct 2′ provided with a shutter 3. In this case, the cover 1 comprises an actuator 8, not shown in the figure, which is designed to pivot the shutter 3 around an axis XX′, between an open position O and a closed position S. The shutter 3 is represented here in the closed position.

The housing 100 also comprises a second, external air input duct 2″, and a third duct 2′″. The arrows Gv, OUT and EXT show respectively the direction of circulation of the air coming from the passenger space of the vehicle in the first duct 2′, coming from the exterior in the second duct 2″, and exiting from the housing via the third duct 2′″.

In the example illustrated, the housing 100 also accommodates a fan 40. In this case, the fan is situated in the third duct 2′″.

In the example illustrated, the second and third ducts 2″ and 2′″ are not elements of the cover 1. Alternatively or in addition, in variants, not illustrated, the cover of the housing comprises at least one second external air input duct, and/or at least one third air output duct.

In particular examples, not illustrated, the second, external air input duct 2″ and/or the third duct 2′″ also comprise(s) a shutter 3, which may be displaced between an open position and a closed position.

FIGS. 2a and 2b illustrate a first duct 2′ of a cover 1 according to an embodiment of the invention.

The cover 1 has a tubular part 2 in this case with a polygonal transverse cross-section, defining a first duct 2′ in which a shutter 3 is fitted articulated around an axis X-X′, in order to be displaced along a predetermined angular course in both directions of rotation. The angular course of the shutter 3 extends for example between stops 4, 5, in order to define respectively an open position O, in which the shutter 3 releases the passage of the air in the first duct 2′, and a closed position S in which the shutter 3 obstructs the passage of the air in the first duct 2′.

FIG. 3 corresponds to a view in cross-section according to III-III of the first duct 2′ of FIGS. 2a and 2b, with the shutter being in an intermediate position between the open position O and the closed position S.

As illustrated in FIG. 3, the shutter 3 is connected to an output shaft 7 of an actuator 8. The actuator 8 is for example an electric small-sized direct current or step motor. The actuator 8 is secured on the exterior, on an exterior lateral wall 12 of the first duct 2′.

In this case, the actuator 8 is also designed to receive a signal 10 coming from a battery control system—not represented—and/or from an autonomous sensor—not represented. The actuator controls the closed position S of the shutter 3 after receipt of a signal 10 for detection of a trigger event.

The shutter 3 illustrated comprises a central part 13 which is articulated around the axis XX′, and two lateral parts in order to block the passage of the air. The displacement between the open position O and the closed position S is in this case reversible. Thus, according to the signal 10 received, the actuator 8 may control the displacement of the shutter 3 from the closed position S to the open position O.

FIGS. 4a and 4b illustrate another example of a first duct 2′ of a cover 1 according to the invention The cover 1 comprises an actuator 8, in this case, a return unit system, in order to displace the shutter 3 in the interior of the first air circulation duct 2′, between an open position O and a closed position S. In FIG. 4a, the shutter 3 is maintained in the open position O. The actuator 8 comprises a return unit—in this case a spring—and a blocking lock which maintains the spring in the extended position. As shown by the double arrow Gv, the air circulates freely in the first duct 2′, in both directions, i.e. from the passenger space of the mobility vehicle to the battery and conversely.

When a trigger event occurs, the lock is unblocked, thus releasing the return unit 18, which then closes the shutter 3 and maintains it in the closed position. FIG. 4b illustrates this closed position, in which the air may no longer circulate between the passenger space of the mobility vehicle and the battery. In particular, the shutter 3 prevents any noxious fumes or burning air, or flames, from reaching the passenger space.

The displacement between the open position O and the closed position S is in this case irreversible. Exterior intervention is necessary in order to return the return unit 18 to the locked position, or replace the lock.

In the examples illustrated schematically, the cover and the housing of the examples illustrated are made of thermoplastic material with a thickness of a few millimeters. The cover and the housing according to the invention are not limited to a particular material. Any material known to persons skilled in the art in the domain of covers or housings for mobility vehicle batteries may be used within the context of the invention. In particular, the cover and/or the housing may comprise elements which are made from different materials.

1. A cover for a battery of a mobility vehicle, which is designed to be installed between the battery and a passenger space of the mobility vehicle, said cover comprising at least one first air circulation duct provided with a shutter, which may be displaced between an open position and a closed position, and an actuator in order to displace the shutter between the open position and the closed position, the actuator being designed to receive a signal obtained from a battery control system and/or from an autonomous sensor, and to control the closure and/or the opening of the shutter after receipt of a trigger event signal, the battery control system comprising at least one battery alert threshold, beyond which the shutter is displaced and remains in the closed position.

2. The cover as claimed in claim 1, wherein the at least one alert threshold is a temperature alert threshold of the battery.

3. The cover as claimed in claim 2, wherein a maximum value of the at least one temperature alert threshold of the battery is previously predefined, with the maximum value of the at least one temperature alert threshold of the battery being between 60° C. and 120° C., preferably between 80° C. and 120° C.

4. The cover as claimed in claim 1, wherein the at least one alert threshold is an alert threshold for the presence of gas corresponding to a predefined maximum level for the presence of a gas in the air, such as, in particular, the gases with the chemical compositions H2 and/or CO2 and/or CO and/or HF and/or POF3.

5. The cover as claimed in claim 1, the cover comprising at least one second air circulation duct, in particular an external air input duct, and/or at least one third air circulation duct, in particular an air output duct.

6. The cover as claimed in claim 1, the shutter being of the drum type, or a butterfly valve or a sliding valve.

7. The cover as claimed in claim 1, the actuator being selected from among a gear motor, a step motor, a toothed rack or pinion system, or a return unit system.

8. The cover as claimed in claim 1, wherein the actuator is connected to an external wall of the first air circulation duct.

9. The cover as claimed in claim 1, the displacement between the open position and the closed position being reversible.

10. The cover as claimed in claim 1, the displacement of the shutter being irreversible, with the shutter which is being displaced then being maintained locked in the closed position when the at least one alert threshold of the battery control system has been reached.

11. A battery housing comprising a cover as claimed in claim 1, said housing comprising in particular at least one second air circulation duct, in particular an external air input duct, and/or at least one third air circulation duct, in particular an air output duct.

12. An assembly for a mobility vehicle comprising a battery and a
a cover as claimed in claim 1.

13. The cover as claimed in claim 2, wherein the at least one alert threshold is an alert threshold for the presence of gas corresponding to a predefined maximum level for the presence of a gas in the air, such as, in particular, the gases with the chemical compositions H2 and/or CO2 and/or CO and/or HF and/or POF3.

14. The cover as claimed in claim 2, the cover comprising at least one second air circulation duct, in particular an external air input duct, and/or at least one third air circulation duct, in particular an air output duct.

15. The cover as claimed in claim 2, the shutter being of the drum type, or a butterfly valve or a sliding valve.

16. The cover as claimed in claim 2, the actuator being selected from among a gear motor, a step motor, a toothed rack or pinion system, or a return unit system.

17. The cover as claimed in claim 2, wherein the actuator is connected to an external wall of the first air circulation duct.

18. The cover as claimed in claim 2, the displacement between the open position and the closed position being reversible.

19. The cover as claimed in claim 2, the displacement of the shutter being irreversible, with the shutter which is being displaced then being maintained locked in the closed position when the at least one alert threshold of the battery control system has been reached.

20. A battery housing comprising a cover as claimed in claim 2, said housing comprising in particular at least one second air circulation duct, in particular an external air input duct, and/or at least one third air circulation duct, in particular an air output duct.
